(19) United States
(12) Patent Application Publication
(10) Pub. No.: US 2002/0160312 A1
(43) Pub. Date: Oct. 31, 2002

(54) Method for producing photoresist master for optical information medium, and method for producing stamper for optical information medium

(75) Inventors: Hisaji Oyake, Tokyo (JP); Hiroaki Takahata, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Tokyo (JP)

(21) Appl. No.: 10/083,596

(22) Filed: Feb. 27, 2002

(30) Foreign Application Priority Data
Feb. 27, 2001 (JP) 2001-053030

(51) Int. Cl. G03C 1/492; G03C 1/76

(52) U.S. Cl. 430/320; 430/945; 430/273.1; 430/510

(57) ABSTRACT

A method for producing a photoresist master adapted for use in the manufacture of an optical information medium is provided. This method has enabled formation of a fine pattern having a minimum width which is about half of the wavelength used for the exposure, and in this method, decrease in the pattern height has been suppressed and tapering of the pattern profile has been improved. In this method comprising the steps of applying a photoresist layer on a substrate, exposing the photoresist layer to a laser beam to form a latent image in the photoresist layer, and developing the latent image to form a protrusion/depression pattern to thereby produce the photoresist master, and in this method; a light absorbing layer is formed between the substrate and the photoresist layer and in contact with the photoresist layer, and the light absorbing layer exhibits light absorption at the wavelength of said laser beam.

### BACKGROUND OF THE INVENTION

1. Technical Field

This invention relates to a method for producing a stamper which is used in producing an optical information medium having protrusion/depression pattern such as grooves and prepits, and also, a method for producing a photoresist master used in such stamper.

2. Background Art

Optical disks include write once and rewritable optical recording disks and read only disks. Optical recording disks have a recording layer formed on a disk substrate which is provided on its surface with (guide) grooves for tracking and other purposes. On the other hand, the read only disks have information-bearing pits integrally formed on the surface of the disk substrate.

The disk substrate is produced by injection molding a resin or by transferring the pattern using a stamper having a negative pit or groove pattern. The stamper usually comprises a film of a metal such as nickel. In order to manufacture such stamper, a photoresist master is first prepared.

The following process is generally employed for preparing the photoresist master. First, a photoresist layer is applied on the surface of a glass substrate. The photoresist layer is then exposed to patterning beams such as laser beams to form a latent image of the desired pattern, followed by development. A protrusion/depression pattern is thereby formed on the photoresist layer, and the photoresist master is produced.

In manufacturing a stamper by using such photoresist master, a metal thin film of nickel or the like is formed by sputtering, electroless plating or the like to thereby impart electric conductivity to the surface of the photoresist layer. Electroforming is then effected to deposit a film of nickel or the like on the metal thin film. Then the laminate of the metal thin film and the electroformed film is stripped from the photoresist layer. The laminate is ready for use as the stamper (master). This stamper master may be used as the stamper directly, although a stamper mother may be prepared from the stamper master and used as the stamper. The stamper mother is prepared by electroforming a film on the surface of the stamper master and stripping the electroformed film. It is recommended to previously oxidize the surface of the stamper master so that the electroformed film may be readily stripped therefrom. Alternatively, a stamper child may be similarly prepared using the stamper mother and used as the stamper.

In the process of preparing a photoresist master, the minimum width of the latent image pattern formed in the photoresist layer is limited by the diameter of a laser beam spot at the surface of the photoresist layer. The beam spot diameter w is represented by w=k·λ/NA wherein λ is the wavelength of the laser beam, NA is the numerical aperture of an objective lens in an optical system, and k is a constant which is determined by the aperture shape of the objective lens and the intensity distribution of an incident light flux.

However, even if the pattern had a width which does not theoretically exceed the limit set by the spot diameter, height of the pattern is likely to become reduced due to the thinning of the photoresist layer, and sharpness of the pattern is also likely to become insufficient due to the tapered pattern profile. It is believed that one major cause for such inconvenience is the reflection of the laser beam at the interface between the photoresist layer and the glass substrate. To be more specific, it is believed that the reflected laser beam returns to the photoresist layer to induce a multiple exposure state and this results in the ambiguous latent image pattern. In order to prevent such reflection, Japanese Patent Application Laid-Open No. (JP-A) 263140/1992 proposes a glass master provided with a non-reflective coating which is adapted for use in the manufacture of an optical disk stamper. The anti-reflective coatings disclosed in JP-A 263140/1992 are a MgF₂ film (mono-layer, anti-reflective film) and a multi-layer dielectric film (multi-layer, anti-reflective film). Both of these coatings comprise an inorganic material, and the reflection is prevented by means of optical interference.

### SUMMARY OF THE INVENTION

Based on the disclosure of the JP-A 263140/1992, the inventors of the present invention produced a photoresist master by using a substrate provided with a non-reflective coating comprising a film of an inorganic material, and a stamper was produced by using this photoresist master. However, when the pattern formed was a fine pattern having a minimum width which is about half the wavelength used in the exposure, provision of the non-reflective coating was far from being effective in suppressing the decrease of the pattern height and improving the pattern sharpness.

In view of the situation as described above, an object of the present invention is to enable formation of a fine pattern having a minimum width which is about half of the wavelength used for the exposure in the photoresist master used in producing an optical information medium, wherein decrease in the pattern height has been suppressed and tapering of the pattern profile has been improved.

Such objects are attained by the present invention as described in (1) to (7), below.

(1) A method for producing a photoresist master for an optical information medium comprising the steps of

applying a photoresist layer on a substrate,

exposing the photoresist layer to a laser beam to form a latent image in the photoresist layer, and

developing the latent image to form a protrusion/depression pattern to thereby produce the photoresist master; wherein

a light absorbing layer is formed between said substrate and said photoresist layer and in contact with said photoresist layer, and said light absorbing layer exhibits light absorption at the wavelength of said laser beam.

(2) The method according to the above (1) wherein said light absorbing layer contains an organic compound which exhibits light absorption at the wavelength of said laser beam.

(3) The method according to the above (2) wherein the organic compound used is at least one member selected from a photoinitiator, a co-initiator, and a dye.

(4) The method according to any one of the above (1) to (3) wherein the relation:

t_{R}/λ_{E}≦0.6

is satisfied when said laser beam has a wavelength of λ_{E} (unit: nm), and said photoresist layer has a thickness of t_{R} (unit: nm).

(5) The method according to any one of the above (1) to (4) wherein the relation:

W_{P}/λ_{E}≦0.9

is satisfied when said laser beam has a wavelength of λ_{E} (unit: nm), and said protrusion/depression pattern formed in the photoresist layer has a minimum width of Wₚ (unit: nm).

(6) A method for producing a stamper for an optical information medium by using the photoresist master for an optical information medium produced by the method of any one of the above (1) to (5), wherein said method comprises the step of transcribing said protrusion/depression pattern formed in the photoresist layer to a metal film.

(7) The method according to the above (6) comprising the steps of

forming a nickel thin film on said protrusion/depression pattern formed in the photoresist layer by electroless plating,

forming an electroformed film on said nickel thin film, and

peeling said metal film comprising said nickel thin film and said electroformed film to thereby produce the metal film having the protrusion/depression pattern transcribed thereto.

It is to be noted that the term “electroformed film” is used herein as “a film formed by plating” as often is the case in the art, namely, in the case of stamper production.

### BRIEF DESCRIPTION OF THE DRAWINGS

FIG. 1 is a photograph taken by an atomic force microscope of the fine pattern formed on the substrate of the stamper produced by using the present invention.

FIG. 2 is a photograph taken by an atomic force microscope of the fine pattern formed on the substrate of the stamper produced by a conventional method.

### DESCRIPTION OF THE PREFERRED EMBODIMENTS

In the production of the photoresist master according to the present invention, a light absorbing layer is formed between the substrate and the photoresist layer and in contact with the photoresist layer, and this light absorbing layer exhibits light absorption at the wavelength of the laser beam used.

This light absorbing layer preferably contains an organic compound which exhibits light absorbency (hereinafter also referred to as a light absorber). The light absorber is preferably at least one compound selected from a photoinitiator, a co-initiator, and a dye. The photoinitiator is an organic compound which is typically used in combination with a light curing resin, and it generates a radical by absorbing UV or other light. In the case of the co-initiator, the co-initiator itself is not activated by the UV irradiation. However, when the co-initiator is used in combination with a photoinitiator, the photoinitiation is more efficiently promoted compared to the use of the photoinitiator alone, and the curing proceeds more efficiently. In the present invention, use of the co-initiator is preferable in view of its higher stability compared to the photoinitiator which undergoes decomposition simultaneously with the generation of the radical. An aliphatic or an aromatic amine is typically used for the co-initiator. In the present invention, it is preferable to use for the co-initiator at least one of 4,4′-bis(dimethylamino) benzophenone, 4,4′-bis(diethyl-amino)benzophenone, ethyl 4-dimethylaminobenzoate, (n-butoxy)ethyl 4-dimethylaminobenzoate, isoamyl 4-dimethylaminobenzoate, and 2-ethylhexyl 4-dimethylamino-benzoate. Among these, the most preferred are the benzophenone compounds.

Generally, the light absorbing layer containing the light absorber is preferably formed by the procedure as described below. First, the light absorber is dissolved in a solvent to produce a coating solution. If desired, the coating solution may also contain a thermally crosslinkable compound in addition to the light absorber. When the coating containing the thermally crosslinkable compound in addition to the light absorber is cured by heating after its coating, and the photoresist layer is formed on the thus cured coating, mixing of the light absorbing layer with photoresist layer can be suppressed. The coating solution may also contain an optional additive such as an adhesion aid which improves adhesion of the light absorbing layer to the photoresist layer, or a surfactant. It is to be noted that a coupling agent layer may also be formed between the substrate and the light absorbing layer to thereby improve the adhesion between the substrate and the light absorbing layer.

The content of the light absorber in the light absorbing layer is preferably in the range of 10 to 70 mass %. Sufficient light absorption will not be attained when the content is too low, while an excessively high content of the light absorber may result in an insufficient film strength of the light absorbing layer due to the relatively reduced content of the cured product of the thermally crosslinkable compound. It is to be noted that the light absorbing layer may preferably have an absorption coefficient (herein used as an extinction coefficient) k of at least 0.01, and more preferably at least 0.1 at the wavelength of the laser beam used. When the absorption coefficient is too small, sufficient absorption of the laser beam by the light absorbing layer will be difficult.

The thickness of the light absorbing layer is not particularly limited as long as the light absorbing layer is formed to a thickness that allows sufficient absorption of the laser beam used for the exposure of the photoresist layer. When the thickness of the light absorbing layer is insufficient, the laser beam will not be sufficiently absorbed and the photoresist layer is likely to experience a multiple exposure and deformation of the latent image. On the other hand, if the light absorbing layer were formed to a thickness of more than 300 nm, the layer will not exhibit significantly improved light absorbency for the laser beam and the material used for the light absorbing layer is likely to be wasted. Furthermore, when the light absorbing layer is deposited to a thickness in excess of 300 nm, heat will be excessively accumulated in the light absorbing layer upon irradiation of the laser beam, and this is likely to result in the thermal decomposition of the photoresist layer rendering the stable exposure difficult. In view of such situation, the light absorbing layer is preferably deposited to a thickness of 1 to 300 nm, and more preferably to a thickness of 10 to 200 nm. The degree of the thermal decomposition of the photoresist layer caused by the heat accumulation in the light absorbing layer varies with the power of the laser beam irradiated, and therefore, the thickness of the light absorbing layer may be increased beyond 300 nm, namely, to a thickness of up to 500 nm in the case when the laser beam used for the exposure is of relatively low power.

The present invention is particularly effective when the relation:

t_{R}/λ_{E}≦0.6,

and in particular, when the relation:

t_{R}/λ_{E}≦0.3

is satisfied when the laser beam has a wavelength of λ_{E} (unit: nm), and the photoresist layer has a thickness of t_{R} (unit: nm). When the relative thickness of the photoresist layer in relation to the wavelength λ_{E} (i.e. t_{R}/λ_{E}) is too large, the effect of the present invention to improve the pattern profile will be less significant since the tapering of the pattern profile caused by the laser beam reflected from the upper surface of the substrate is less significant. It is to be noted that the relative thickness t_{R}/λ_{E} is generally limited by the width and the depth of the protrusion/depression pattern formed, and it is generally such that:

0.03≦t_{R}/λ_{E}.

The present invention is particularly effective when the relation:

W_{P}/λ_{E}≦0.9,

and in particular, when the relation:

W_{P}/λ_{E}≦0.5

is satisfied when the protrusion/depression pattern formed in the photoresist layer has a minimum width of W_{P} (unit: nm). When the relative minimum width in relation to the wavelength λ_{E} (i.e. W_{P}/λ_{E}) is too large, the effect of the present invention to improve the pattern profile will be less significant since the tapering of the pattern profile caused by the laser beam reflected from the upper surface of the substrate is less significant. However, when the relative minimum width W_{P}/λ_{E} is too small, formation of high precision pattern will not be possible due to the optical limitation. Therefore, the relative minimum width is preferably such that:

0.2≦W_{P}/λ_{E},

and more preferably:

0.3≦W_{P}/λ_{E}.

It should be noted that the protrusion/depression pattern formed in the photoresist layer is the pattern provided for the purpose of forming grooves and prepits in the medium. In the formation of a medium provided with grooves, the minimum width is the minimum width value of the depression or the protrusion used in forming the groove or the land (the area that extends between two adjacent grooves).

The wavelength λ_{E} of the laser beam used in the present invention is not particularly limited. However, use of a shorter wavelength λ_{E} is preferable since use of a shorter wave length λ_{E} will enable formation of a finer pattern. Use of laser having an extremely short wavelength is unpractical and development of the photoresist that corresponds to such laser is also difficult. In view of such situation, the wavelength λ_{E} is preferably in the range of 200 to 500 nm, and more preferably, in the range of 230 to 420 nm.

The present invention is effective in a process wherein the pattern is formed by exposure to laser beam. In other words, this invention is useful in a process wherein energy distribution of the plane irradiated by the beam during the exposure is Gaussian distribution and not uniform.

In the present invention, the cross section of the protrusion/depression pattern formed in the photoresist layer may be rectangular, trapezoidal, or triangular. For example, when a channel pattern corresponding to the grooves of the medium is formed, the cross section may be either a channel with U-shaped cross section or a channel with V-shaped cross section. If intensity of the laser beam used in the formation of the latent image is relatively high to reach the lower surface of the photoresist layer, the channel formed will be U-shaped. On the other hand, a V-shaped channel will be formed if the laser beam used has a relatively low intensity not reaching the lower surface of the photoresist layer. It is also possible that both types of channels are present on one photoresist master.

In the present invention, the substrate used in the manufacture of the photoresist master may comprise any material, for example, a glass, a metal, a semimetal, or the like.

When a glass substrate is irradiated with UV and the amount of light reflected from the surface (the surface of the beam incidence) and the back surface of the substrate is evaluated, more light is reflected from the surface of the substrate. Furthermore, when the light absorbing layer is formed on the surface of the beam incident surface of the glass substrate, the laser beam that reaches the photoresist layer after reflecting at the back surface of the glass substrate will be the one that had passed the light absorbing layer twice, and the beam reaching the photoresist layer will have a considerably reduced intensity. Therefore, the present invention wherein the light absorbing layer is formed on the beam incident side of the substrate can more efficiently reduce the effect on the photoresist layer of the light reflected from the substrate compared to the case wherein the light absorbing layer is formed on the back surface of the glass substrate.

It is to be noted that the light absorbing layer may be optionally provided on the rear surface of the substrate, namely, on the surface opposite to the surface on which the photoresist layer is formed, in addition to the front surface of the substrate.

### EXAMPLES

### Example 1

Stamper No. 1

On a polished glass substrate was formed a layer of a coupling agent, and a coating containing a light absorber was spin coated on the coupling agent layer. The coating solution used was SWK T5D60 manufactured by Tokyo Ouka Kogyo K. K. containing 4,4′-bis(diethylamino)benzophenone as the light absorber. The coating after thermal curing had an absorption coefficient for i-line (wavelength, 365 nm) of 0.35, and an absorption coefficient of 0.31 at the wavelength of 351 nm. This coating was baked at 180° C. for 5 minutes for curing while the residual solvent was removed. The resulting light absorbing layer had a thickness of 52 nm. Content of the light absorber in the light absorbing layer was 60.8 mass %.

Next, a photoresist (DVR100 manufactured by Nippon Zeon K. K.) was spin coated on the light absorbing layer and baked to evaporate the residual solvent to thereby obtain a photoresist layer of 24 nm thick.

The photoresist layer was then exposed to Kr laser (wavelength λ_{E}, 351 nm) by using a cutting machine manufactured by Sony Corp. in order to form a groove pattern at a pitch of 300 nm and a groove width (minimum width of the protrusion/depression pattern, W_{P}) of 150 nm. The photoresist layer was then developed to produce the photoresist master. It should be noted that the t_{R}/λ_{E} in this case was 24/351, namely, 0.068.

A nickel thin film was then formed on the photoresist layer-bearing surface of the photoresist master by electroless plating. Another nickel film was electroformed on the nickel thin film. The laminate of the nickel thin film and the electroformed nickel film was stripped from the photoresist layer, yielding stamper No. 1.

Stamper No. 2

Stamper No. 2 was produced by repeating the procedure of Stamper No. 1 except that a CeO₂ film with a thickness of 100 nm formed by sputtering was used for the light absorbing layer, and that the photoresist layer was applied to the CeO₂ film after forming a coupling agent layer. It is to be noted that the CeO₂ film of 100 nm thick functions as an anti-reflection layer by means of optical interference at the wavelength used for the exposure.

Evaluation

The protrusion/depression pattern formed in each stamper was evaluated for the height of the protrusions, half width of the protrusion height, and tilt angle of the edges of the protrusions by using an AFM (atomic force microscope). The results are shown in Table 1.

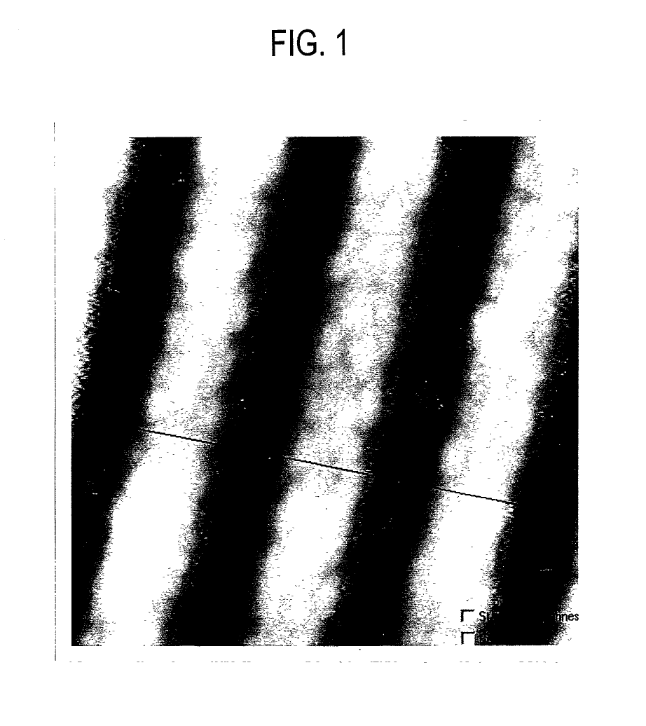

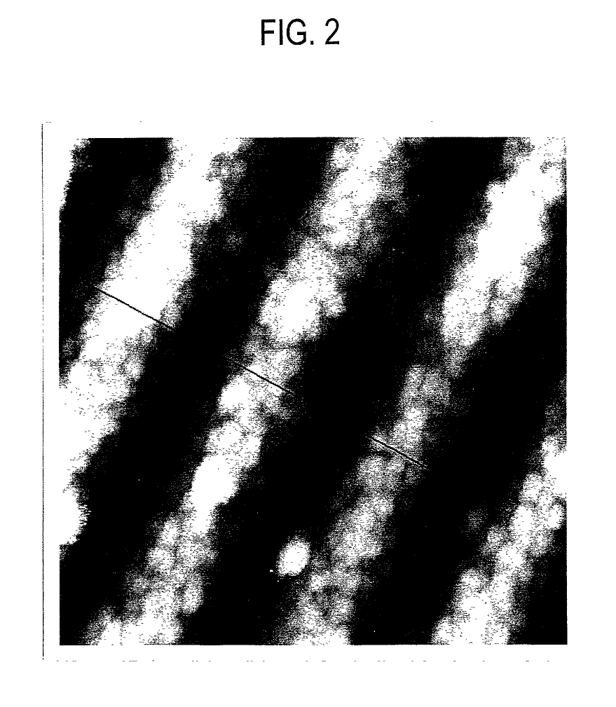

FIGS. 1 and 2 show the AFM images of the stamper Nos. 1 and 2, respectively. In these AFM images, the region of darker color corresponds to the area of depression while the region of lighter color corresponds to the protrusion area.

TABLE 1

| | | | | Half | Tilt angle | Tilt angle |
|---|---|---|---|---|---|---|
| Stamper | W_{P} | | Height | width | of right | of left |
| No. | (nm) | W_{P}/λ_{E} | (nm) | (nm) | edge (deg) | edge (deg) |
| 1 | 150 | 0.427 | 22.19 | 152 | 22.0 | 25.4 |
| 2 | | | | | | |
| (Comp.) | 150 | 0.427 | 13.85 | 178 | 8.4 | 7.5 |

The merits of the present invention is evident from Table 1. In the stamper produced by applying the present invention, the pattern formed exhibited quite sharp cross-section although the minimum width W_{P} of the protrusion/depression pattern had been smaller than ½ of the exposure wavelength λ_{E} and the protrusion height was very close to the thickness of the photoresist layer before the patterning as a result of reduced thinning of the photoresist layer.

### Example 2

Stampers were produced by repeating the procedure of Stamper No. 1 of Example 1 except that the photoresist layer was deposited to a thickness of 25 nm, and the minimum width of the protrusion/depression pattern (the groove width) W_{P} was set in the exposure at the values shown in Table 2. Stampers for comparison purpose were also produced in a similar procedure except that the photoresist master used had no light absorbing layer.

The stampers were evaluated for their protrusion height and tilt angle of the edge of the protrusions by using an AFM. The results are shown in Table 2. It is to be noted that the average tilt angle shown in Table 2 is the average of the left and the right edges.

TABLE 2

| | | | | Average tilt | |
|---|---|---|---|---|---|
| | | Height (nm) | | angle (deg) | |
| W_{P} | | Light absorbing layer | | Light absorbing layer | |
| (nm) | W_{P}/λ_{E} | Present | Absent | Present | Absent |
| 150 | 0.427 | 23.6 | — | 21.2 | — |
| 162.5 | 0.463 | 23.8 | 19.9 | 21.3 | 8.4 |
| 175 | 0.500 | 24.5 | 24.3 | 20.1 | 9.2 |
| 197.5 | 0.563 | — | 24.5 | — | 10.5 |

As evident from Table 2, use of the photoresist master provided with the light absorbing layer resulted in the markedly increased tilt angle of the protrusions, namely, in the remarkably reduced tapering of the pattern profile. It is also evident that the effect of suppressing the decrease in the pattern height is particularly high when the relation:

W_{P}/λ_{E}<0.5

is satisfied.

The experiment as described below was also conducted.

A stamper was produced by repeating the procedure of the stamper No. 1 of Example 1 except that the relative thickness of the photoresist layer in relation to the wavelength λ_{E} (i.e. t_{R}/λ_{E}) was 1.3. The pattern formed on the resulting stamper was sufficiently sharp. However, when an optical disk substrate was formed by using this stamper, and an optical disk was produced by forming a recording layer on such substrate, this optical disk failed to produce the tracking signal (signal produced by the grooves) required for its use as an optical disk.

### MERITS OF THE INVENTION

In the present invention, a light absorbing layer is provided in contact with the photoresist layer in the manufacturing of the photoresist master, and as a consequence, decrease in the pattern height as well as tapering of the pattern profile is suppressed even if the minimum width W_{P} of the protrusion/depression pattern were as small as half or less of the exposure wavelength λ_{E}.

Japanese Patent Application No. 53030/2001 is incorporated herein by reference.

Although some preferred embodiments have been described, many modifications and variations may be made thereto in the light of the above teachings. It is therefore to be understood that within the scope of the appended claims, the invention may be practiced otherwise than as specifically described.

1. A method for producing a photoresist master for an optical information medium comprising the steps of
applying a photoresist layer on a substrate,
exposing the photoresist layer to a laser beam to form a latent image in the photoresist layer, and
developing the latent image to form a protrusion/depression pattern to thereby produce the photoresist master; wherein
a light absorbing layer is formed between said substrate and said photoresist layer and in contact with said photoresist layer, and said light absorbing layer exhibits light absorption at the wavelength of said laser beam.

2. The method according to claim 1 wherein said light absorbing layer contains an organic compound which exhibits light absorption at the wavelength of said laser beam.

3. The method according to claim 2 wherein the organic compound used is at least one member selected from a photoinitiator, a co-initiator, and a dye.

4. The method according to claim 1 wherein the relation:
t_{R}/λ_{E}≦0.6
is satisfied when said laser beam has a wavelength of λ_{E} (unit: nm), and said photoresist layer has a thickness of t_{R} (unit: nm).

5. The method according to claim 1 wherein the relation:
W_{P}/λ_{E}≦0.9
is satisfied when said laser beam has a wavelength of λ_{E} (unit: nm), and said protrusion/depression pattern formed in the photoresist layer has a minimum width of W_{P} (unit: nm).

6. A method for producing a stamper for an optical information medium by using the photoresist master for an optical information medium produced by the method of claim 1, wherein said method comprises the step of transcribing said protrusion/depression pattern formed in the photoresist layer to a metal film.

7. The method according to claim 6 comprising the steps of
forming a nickel thin film on said protrusion/depression pattern formed in the photoresist layer by electroless plating,
forming an electroformed film on said nickel thin film, and
peeling said metal film comprising said nickel thin film and said electroformed film to thereby produce the metal film having the protrusion/depression pattern transcribed thereto.
